(19) United States
(12) Patent Application Publication
(10) Pub. No.: US 2024/0127660 A1
(43) Pub. Date: Apr. 18, 2024

(54) REEL NUDGE DIRECTION BUTTON INPUT FOR SKILL GAMES

(71) Applicant: Bad Dog Games LLC, Fort Worth, TX (US)

(72) Inventors: Brian Cook, Crowley, TX (US); Greg Hammond, Plano, TX (US)

(73) Assignee: Bad Dog Games LLC, Fort Worth, TX (US)

(21) Appl. No.: 18/486,661

(22) Filed: Oct. 13, 2023

Related U.S. Application Data
(60) Provisional application No. 63/379,522, filed on Oct. 14, 2022.

(51) Int. Cl. G07F 17/32; G07F 17/34

(52) U.S. Cl. CPC G07F 17/3209; G07F 17/3213; G07F 17/323; G07F 17/34

(57) ABSTRACT

A system, method, and gaming machine for implementing an optimized nudge operation. The gaming machine includes a processor for executing a set of instructions to implement a game, a memory for storing the set of instructions, nudge logic for determining an effect of all possible nudge operations on initial results of the game when played by a user, and two hardware nudge buttons for selecting among the nudge operations for the game to change the initial results to a final outcome for the game.

### PRIORITY STATEMENT

This application claims priority to U.S. Provisional Patent Application No. 63/379,522, filed on Oct. 14, 2022, titled REEL NUDGE DIRECTION BUTTON INPUT FOR SKILL GAMES, all of which is hereby incorporated by reference in its entirety.

### BACKGROUND

### I. Field of the Disclosure

The illustrative embodiments relate to gaming machines, devices, and methods. More specifically, but not exclusively, the illustrative embodiments relate to an enhanced reel nudge button input for skill games.

### II. Description of the Art

Gaming machines, such as slot machines have been used increasingly by the gaming industry. Often, the popularity of such machines and the associated games is dependent on the likelihood or perceived likelihood of winning money at the machine and the provided entertainment value. Operators strive to employ the most entertaining and exciting machines to increase profitability and enhance the user experience. In some skill-based games, the number of potential skill selections are excessive. The numerous selections may be difficult for a user with disabilities or movement limitations to reach all of the different selections. For example, some gaming machines may display six options separated by significant space for performing a nudge for a three-reel game where a single reel is affected. As a result, the movements required to perform a skill are significant, time between plays is increased resulting in reduced overall revenue. There is a continuing need for gaming machines to provide games and game enhancements that attract players of all abilities, frequent play, and maximize the entertainment value for all.

### SUMMARY OF THE DISCLOSURE

A system, method, and gaming machine for implementing an optimized nudge operation. The gaming machine includes a processor for executing a set of instructions to implement a game, a memory for storing the set of instructions, nudge logic for determining the effect of all possible nudge operations on the initial results of the game when played by a user, and two hardware nudge buttons for selecting among the nudge operations for the game to change the initial results to final results for the game.

A system, method, and gaming machine for implementing enhanced nudging. Game play selections are received from a user. Payment is received for implementing a game. A determination is made whether a nudge would affect the initial results of the game for the benefit of the user utilizing two nudge buttons. A selection from the user is received whether to perform the nudge. Communicating winning information to the user in response to the user performing the nudge to positively affect the initial results.

In other alternative embodiments, the gaming machine may include a payoff mechanism for paying the user for the final outcome of the game. The nudge logic may illuminate one or more of the two hardware nudge buttons to indicate a nudge operation would improve the initial results. The game may be a skill-based game utilizing the nudge operation. The nudge operation may be a skill required by a jurisdiction associated with a location of the gaming machine. The user may be able to make a wrong choice between the two hardware nudge buttons or not selecting one of the two hardware nudge buttons. The game may display at least three reels during the game. The game may display as many as five reels during the game. The two hardware nudge buttons may include an up nudge button and a down nudge button that are applicable to one reel at a time as determined by the nudge logic. The gaming machine may be networked with a number of gaming machines. The gaming machine may be a slot machine or other gaming device. The gaming machine may suggest a nudge to the user utilizing a user interface as a skill hint. The gaming machine may be limited to two dedicated nudge buttons for games of the gaming machine. The nudge may be a change, movement, or swap of at least two components, such as symbols, of the initial results. The nudge operation may be a skill required for the user to win on one or more paylines of the game. The user cannot win without selecting a correct button from the two or more hardware nudge buttons. The selection may include a selection of one of the two nudge buttons or no selection of any buttons. The reels may be virtual or mechanical. The two or more nudge buttons may be proximate a play button of a button deck for initiating the game.

The illustrative embodiments provide a simplified choice of two nudge options from a larger potential set of nudge options. The nudge operations are reduced to two nudge operations including the optimal nudge operation and an opposite of the optimal nudge operation. The gaming machine implements the nudge operation based on a selection from the user to produce the final results.

### BRIEF DESCRIPTION OF THE DRAWINGS

Illustrated embodiments are described in detail below with reference to the attached drawing figures, which are incorporated by reference herein, and where:

FIG. 1 is a pictorial representation of a gaming machine in accordance with an illustrative embodiment;

FIG. 2 is a block diagram of a gaming machine in accordance with an illustrative embodiment;

FIG. 3 is a pictorial representation of a portion of a gaming machine in accordance with an illustrative embodiment;

FIG. 4 is a pictorial representation of a portion of a gaming machine in accordance with an illustrative embodiment;

FIG. 5 is a flowchart of a process for implementing a nudge for a gaming machine in accordance with an illustrative embodiment;

FIG. 6 is a pictorial representation of a nudge operation in accordance with an illustrative embodiment;

FIG. 7 is another pictorial representation of a nudge operation in accordance with an illustrative embodiment; and

FIG. 8 is another pictorial representation of a nudge operation in accordance with an illustrative embodiment.

### DETAILED DESCRIPTION OF THE DISCLOSURE

The illustrative embodiments provide a system, method, and gaming device for utilizing a nudge in a skill game. In one embodiment, a gaming machine or device includes two dedicated buttons for performing a nudge or other skill. Only two buttons are required because the gaming machine utilizes logic to present a selection for the only viable nudge. The logic determines whether nudges are available and what movements of the reels would be required to win to present the appropriate information, or selections to the user. For example, the second reel presented to the user during gameplay may need to be nudged up for the user to win. The user must select the up nudge button to win. It is a skill game because the user must make the appropriate selection of the nudge buttons, up or down. In other words, there is the potential for user error, non-selection, or nonuse of the nudge buttons.

In another embodiment, the appropriate button (up or down) may be highlighted or lit up. The applicable reels or symbols may also be highlighted (e.g., 1-5 reels of a multi-reel game). As a result, the chances of the user winning by making the right nudge selection are increased. The gaming machine may also provide suggestions, guidance, or recommendations regarding the nudge button that should be selected. For example, portions of the user interface, such as displays, touchscreens, speakers, tactile/vibration components, and other output devices of the gaming machine may be utilized to provide suggestions, guidance, or recommendations regarding utilization of the nudges.

The various embodiments improve the ability of users with disabilities or limited motion to play the game and exhibit the necessary skill button. The nudge buttons whether physical or virtual are reduced and positioned close to the play or start button and other inputs of the gaming machine. For example, the nudge or skill buttons or indicators may be positioned close to a button deck of the gaming machine. As a result, playing the game is more comfortable and faster enhancing gameplay.

In another embodiment, the nudge buttons may be virtual or soft buttons that may be presented only for the applicable reel on a touch screen of the gaming device. As a result, the decisions of the user are easier and the likelihood of winning is increased. The virtual or soft nudge buttons may be presented on a touch interface of the gaming device. For example, two nudge buttons may be presented for a reel that may affect outcome of the game, if nudged (i.e., moved by one symbol). The nudges may be performed in any direction that is applicable to gameplay on the gaming machine, such as up and down, left and right, on the diagonal, between positions, and so forth.

The illustrative embodiments reduce the number of physical buttons or soft buttons utilized by the gaming machine to perform a nudge. Logic of the machine determines the outcome of all possible reel nudges (e.g., movement or rotation of one symbol in one direction or another) and then allows the user to select a nudge operation from a reduced subset of two of the possible nudge operations that includes the optimal nudge operation. As a result, gameplay on the gaming machine is sped up increasing revenue and enhancing the user experience.

The nudge may also represent a skill changing of one of the variables in the game to reach an outcome that is favorable to the user. The change may be for reels, dice, characters, symbols, or other components. The nudge or other skill may be swapping variables (e.g., reels, dice, cards, symbols, characters, letters, numbers, etc.) that must be performed by the user to win in the game or improve the outcome. The user may have a number of choices that must be navigated to win or otherwise improve the outcome. For example, the user may have two, three, four, or more choices to win the game.

In some jurisdictions, gaming laws and/or regulations require players to exhibit some level of skills associated with rewards. The nudge, change, or other skills described herein may meet the requirement for a minimum level of skill required to win a game or otherwise improve the outcome.

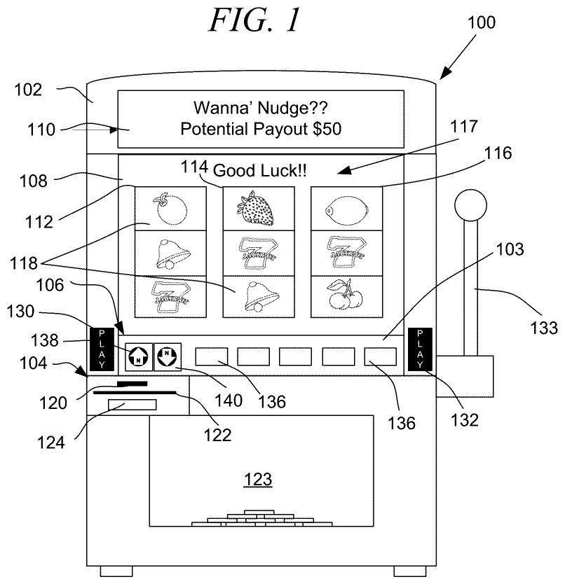

FIG. 1 is a pictorial representation of a gaming machine 100 in accordance with an illustrative embodiment. The gaming machine 100 may be utilized by a user or player in person or remotely (e.g., mobile app, web interface, etc.). The gaming machine 100 may be utilized in gaming establishments, such as casinos, recreation halls, or other locations. The gaming machine 100 may also be utilized in locations where legally allowed. The various structures, configurations, and methods of operation of the gaming machine 100 may vary. In one embodiment, the gaming machine 100 is an electromechanical gaming machine configured to play mechanical, electronic, or video slots or an electronic gaming machine configured to play a video casino game, such as blackjack, slots, keno, blackjack, roulette, bingo, or so forth. The gaming machine 100 includes a housing 102, a value interface 104, a player interface 106, a primary display 108, and a secondary display 110, reels 112, 114, 116 (altogether 117), and symbols 118.

The housing 102 houses and protects the various components and features of the gaming machine 100. The housing 102 may also be referred to as a gaming cabinet that encloses all or portions of the components of the gaming machine 100. Various components may extend from the housing 102. The housing 102 may be formed from metal, plastic, polymers, or a combination thereof. The housing 102 further protects the wiring, busses, connections, and interfaces (i.e., wired, or wireless) between the different components as well as the processors, logic, memories, transceivers, and other logic stored within the housing 102. The various components of the gaming machine 100 may be connected directly to or included within the housing 102.

The value interface 104 may include various features, forms, and functions and may be located in the front of the housing 102 facing the user. The value interface 104 may represent one or more interfaces on different portions of the gaming machine 100. The value interface receives currency, cryptocurrency, tokens, credits, payments, or other units that are inserted or provided by the user. For example, the value interface 104 may represent distributed interface components on different parts of the gaming machine 100 that facilitate right-handed and left-handed users as well as different types of payment, currency, tokens, cryptocurrency, credits, or money. The value interface 104 may include a coin acceptor 120 receiving coin currency (e.g., coins, tokens, chips, etc.). The value interface 104 may also include a reader 122 for receiving credit cards, room cards, payment cards, or so forth. The reader 122 may also be configured to receive paper currency. As a result, the winnings may also be paid to the user in coins, bills, tokens, chips, cryptocurrency, credits, prizes, discounts, compensation, or other payment terms or forms accepted by the user. In one embodiment, the gaming machine 100 may include a dispenser 123 for communicating winnings, such as coins, bills, tokens, vouchers, prizes, or so forth.

The value interface 104 may further include transceiver 124 which may include a QR code reader, bar code reader, radio frequency identification (RFID) reader, Bluetooth reader, Wi-Fi reader, or other interface for receiving information from a display, RFID tag, transceiver (e.g., Bluetooth, Wi-Fi, Zigbee, etc.). In one embodiment, the gaming machine 100 may include one or more buttons, switches, dials, slots, coin acceptors, card readers, scanners, or so forth for receiving payment information and/or gaming information that may be part of the value interface 104 and/or the player interface 106. The value interface 104 and the player interface 106 may include dedicated hardware pushbuttons, switches, dials, sliders, indicators, or other interface components as well as virtual or soft buttons, dials, or other indicators.

The player interface 106 may include dedicated hardware components that the user utilizes to play the games of the gaming machine 100. In one example, the player interface 106 includes play buttons 130, 132. The play buttons 130, 132 or a lever 133 may be utilized to initiate the game. Other buttons 136 may include different options for implementing gameplay. The player interface 106 may also include nudge buttons 138, 140. The nudge buttons 138, 140 are hardware buttons that may be utilized to nudge or move the reels by one symbol in one direction or another or between positions. In one embodiment, the nudge button 138 is for nudging or rotating one of the reels 117 upward and the nudge button 140 is for nudging or rotating one of the reels 117 downward. For example, the nudge buttons 138 may be utilized to nudge the reel 112 up for the user to have a winning payline of triple 7's. Any number of allowed movements between two positions for the reels 117 between positions may also be implemented based on the game. As shown, the nudge buttons 138, 140 may be positioned near the play button 130 or other indicators or selection components of a button deck. The nudge buttons 138, 140 may be positioned with reach of the user's thumb and index finger. As a result, users with disabilities, limited motion, limited stamina, or other physical limitations may be able to play the game and enjoy the benefits of playing. Without the nudge buttons 138, 140 being located proximate the play button 130 certain users may be unable to play various skill-based games. The games may also represent binary skill games where the user must select between two possible selections to win.

In another embodiment, the nudge buttons 138, 140 may be positioned near the play button 132 or lever 136. Alternatively, the gaming machine 100 may include nudge buttons 138, 140 on both sides of the gaming machine 100 to accommodate both right-handed and left-handed players. The nudge buttons 138, 140 may also be positioned in the middle of the gaming machine 100. The nudge buttons 138, 140 may alternatively be foot pedals or buttons operated by the feet of the user. Likewise, virtual nudge buttons may be similarly positioned on the primary display 108 or the secondary display 110.

The gameplay operation and functions of the one or more games implemented by the gaming machine 100 may be displayed to the user on the primary display 108. The primary display 108 may also display any bonus or secondary games associated with the games. The primary display 108 may be a light emitting diode (LED) touchscreen, organic LED touchscreen, liquid crystal display, projection, or other similar display. As noted, the primary display 108 may be a touchscreen thereby allowing users to make game related selections utilizing the primary display 108. For example, the reels 112, 114, 116 may be displayed as a front view of virtual rotating wheels/drums that rotate based on user selections during gameplay. The reels 117 may also display symbols 118 as is known in the art. Random alignment or non-alignment of the symbols 118 or combinations of symbols on the reels 117 may be randomly performed to generate winning or losing paylines. Although not shown, the gaming machine 100 may also include a number of mechanical reels associated with games of the gaming machine 100. The mechanical reels may visually display the outcome associated with one or more pay lines or games being played. The gaming machine 100 may be in “upright” embodiment in which the primary display 108 is oriented relatively vertical to the user. In other embodiments, the primary display 108 may be positioned at a significant angle, or horizontally relative to the user of the gaming machine 100.

The optional secondary display 110 may also be a display similar to the primary display 108 that displays information, such as game types, account information, game play information, user information, game results, odds, wagers, suggestions/options, and so forth. The secondary display 110 may also be a touchscreen or utilize touch sensitive technology. The secondary display 110 represents one or more displays that may be positioned on the gaming machine 100 above, below, to the side or on other portions of the gaming machine 100. For example, the secondary display 110 may represent numerous displays on the gaming machine.

The user may begin gameplay of the wagering game by making a wager through the value interface 104 of the gaming machine. The user may make play selections utilizing the player interface 106 or the primary display 108. In one embodiment, the game may include a number of symbols arranged in an array of reels 117 and includes one or more pay lines that indicates the outcomes of the game. The outcomes are randomly implemented in response to the wagering information provided by the user and the alignment of the various symbols or symbol combinations. Any number of secondary, start, or bonus games may also be implemented by the gaming machine 100.

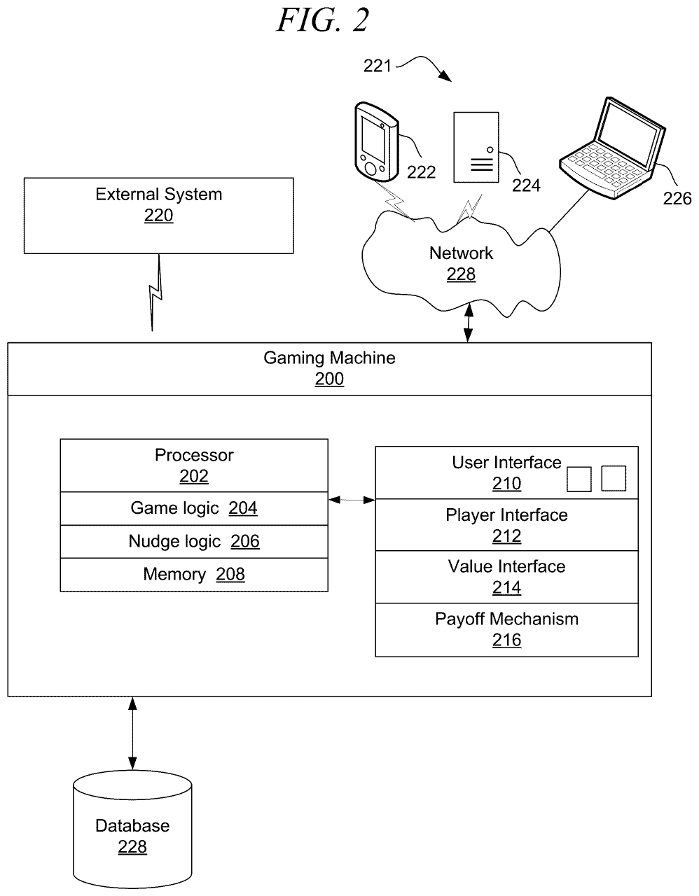

FIG. 2 is a block diagram of a gaming machine 200 in accordance with an illustrative embodiment. In one embodiment, the gaming machine 200 may represent the gaming machine 100 of FIG. 1. The gaming machine may include a processor 202, game logic 204, nudge logic 206, a memory 208, a user interface 210, a player interface 212, a value interface 214, and a payoff mechanism 216.

Each of the devices, systems, and equipment of the gaming machine 200 may include any number of gaming, computing, and telecommunications components, devices or elements which may include processors, memories, caches, busses, motherboards, chips, traces, wires, pins, circuits, ports, interfaces, cards, converters, adapters, connections, transceivers, displays, antennas, operating systems, kernels, modules, scripts, firmware, sets of instructions, and other similar components and software that are not described herein for purposes of simplicity. In one embodiment, the processor 202 is circuitry or logic enabled to control execution of a program, application, operating system, software, macro, kernel, or other set of instructions. The various components of the gaming machine 100 may communicate through any number of input/output circuits, wires, traces, busses, or other communications paths.

The gaming machine 200 may communicate with an external system 220 and devices 222, 224, 226 (altogether devices 221) directly or through one or more networks 228. The external system 220 or devices 221 may represent a gaming network, other gaming machines, gaming servers, cloud systems/networks, mobile devices (e.g., smart phones, tablets, etc.), personal computers, or so forth. In one embodiment, a remote user may play a game offered by the gaming machine 200 utilizing the device 222 through the network 228. In other embodiments, multiple gaming machines may be networked together to increase the payouts, encourage competition, facilitate joint gameplay, and otherwise enhance the profitability and usage of the gaming machine 200.

The processor 202 may be one or more controllers, microprocessors, microcontrollers, central processing units, secondary processors, digital signal processors, application-specific integrated circuits (ASIC), central processing units, or other devices suitable for controlling an electronic device including one or more hardware and software elements, executing software, instructions, programs, and applications, converting and processing signals and information, and performing other related tasks. The processor 202 may be a single chip or integrated with other computing or communications elements. In one embodiment, the processor 202 may execute one or more game programs stored in a computer readable storage medium, such as the memory 208. The processor 202 may perform the random selection (e.g., random number generator) of an outcome from numerous potential outcomes of the game.

The memory 208 may be a hardware component, device, or recording media configured to store data for subsequent retrieval or access at a later time. The memory 208 may be static or dynamic memory. The memory 208 may include a hard disk, random access memory, cache, removable media drive, mass storage, or configuration suitable as storage for data, transactions, instructions, and information. In one embodiment, the memory 208 and processor 202 may be integrated. The memory 208 may use any type of volatile or non-volatile storage techniques and mediums. In one embodiment, the memory 208 may also store a digital ledger and tokens for implementing a blockchain processes. The memory 208 may also store player profiles, game profiles/settings, payment profile, bank account information, preferences, and other applicable information.

The game logic 204 may be the logic that controls various algorithms, programs, hardware, and software that interact to implement the games and receive, aggregate, analyze, rank, process, score, communicate, and distribute data, content, transactions, advertisements, alerts, reports, messages, or so forth. The game logic 204 may utilize any number of thresholds, parameters, rules, laws, criteria, algorithms, instructions, or feedback to interact with users/players, hosts, advertisers, and other interested parties and to perform other automated processes. In one embodiment, the game logic 204 may be utilized to implement gameplay for a three-reel slots game.

In one embodiment, the gaming machine 200 may include virtual or mechanical slots with multiple symbols on each of the reels. If the same symbol in the same location on different reels are aligned is a specified pattern (e.g., horizontally, diagonally, etc.) defined by the game this is a winning payline. Any number of predefined combinations of symbols may specify the potential paylines for the user making clear how and when the user may win when playing the game. In one embodiment, the gaming machine 200 may present information and data regarding the rules, paylines, winning information, and payouts for one or more games of the gaming machine 200. The gaming machine 200 may explain how and when nudges are earned, purchased, allocated, won, or otherwise provided to the user. For example, before playing the user may purchase a specified number of nudges. As previously noted, the game implemented by the gaming machine may require that a skill be demonstrated for the user to even have the possibility of winning.

The nudge logic 206 is operable to display nudge information, data, and recommendations to the user. The availability of nudges may be built into gameplay for the gaming machine 200. The nudge logic 206 may determine with the user may benefit from a nudge. A standard nudge is motion of one of the reels in one or more directions. For example, the user may nudge one of the reels up or down at any time during gameplay. In one embodiment, the game logic 204 and/or the nudge logic 206 may be logic that are integrated with the processor 202. A nudge may alternatively represent a change of at least two components (e.g., symbols, characters, dice, text, selections, cards, etc.). For example, the user may be able to nudge, swap, or moves symbols, up, down, left, right, diagonally, or in other configurations. The game logic 204 and the nudge logic 206 may be hardware logic. The game logic 204 and the nudge logic 206 may also represent algorithms, scripts, software, or sets of instructions that may be stored in the memory 208 and executed by the processor 202 to perform the methods herein described. The algorithm utilized by the nudge logic 206 may determine which possible changes to the reels may be most beneficial to the user (e.g., winnings, tokens, etc.). The most beneficial nudge opportunity may then be presented to the user.

As previously noted in FIG. 2, the value interface 214 may be utilized to receive money, credits, tokens, or other forms of payment from the user. Payments may be received at any time before or during the game (or even potentially after the game). The value interface 214 may include any number of physical components (e.g., slots, readers, scanners, transceivers, etc.), hardware, software, and/or firmware for processing hard currency (e.g., coins, bills, etc.), tokens, chips, credits, payment cards (e.g., debit cards, credit cards, room cards, prepaid cards, etc.), wireless payments, codes, identifiers, or other payment information, data, and/or signals.

The user interface 210 may include any number of primary and/or secondary displays, projects, display components, as well as dedicated buttons, selectors, dials, or hardware interfaces and software. The user interface 210 may include one or more touch screens that display one or more graphical user interfaces. The user interface 210 may display gaming information and content, such as images, icons, video, animations, and other content that may be opaque, semi-transparent (e.g., translucent), transparent, or so forth. The user interface 210 may also include one or more speakers, microphones, tactile components, vibration components, or so forth. The content displayed by the user interface 210 may be displayed in two dimensions or three dimensions. The content may utilize specialized holographic displays, special glasses/goggles, or other methods to display the content to the user(s) of the gaming machine 200. In one embodiment, the player interface 212 may be integrated with the user interface 210.

The player interface 212 may include the buttons, dials, levers, switches, or other selectors for providing information and details for playing the one or more games of the gaming machine 200. The player interface 212 may include dedicated push buttons, button panels, touch keys, and other selectors for receiving input from the user. The player interface 212 may also work with touch screens, soft buttons/virtual buttons, virtual indicators, and other interaction systems. The player interface 212 may also receive input verbally/audibly, tactilely (e.g., taps, swipes, etc.), visually (e.g., eye motion tracker, gesture interpreter, etc.), and utilizing other systems. For example, to reduce the number of users that may be required to touch the gaming machine 200, one or more cameras or motion trackers may be utilized to visually determine the selections of the user without requiring that the player interface 212 is physically touched.

The payoff mechanism 216 is configured to award a payoff to the user in response to certain winning outcomes that may occur in the one or more games of the gaming machine 200. The payoff from the payoff mechanism 216 may be provided in the form of points, coins, bills, tickets, coupons, cards, tokens, vouchers, goods, services, or other winnings. For example, the payoff mechanism 216 may include a coin outlet and a ticket printer. Any number of mechanisms, components, or systems may be implemented with the payoff mechanisms 216, such as cards, coins, tokens, cards (e.g., credit cards, smart cards, room cards, etc.), crypto wallets, QR codes, payment signals, or so forth. A seat, chair or other furniture component may be integrated with the gaming machine 100 and may include any of the components herein described.

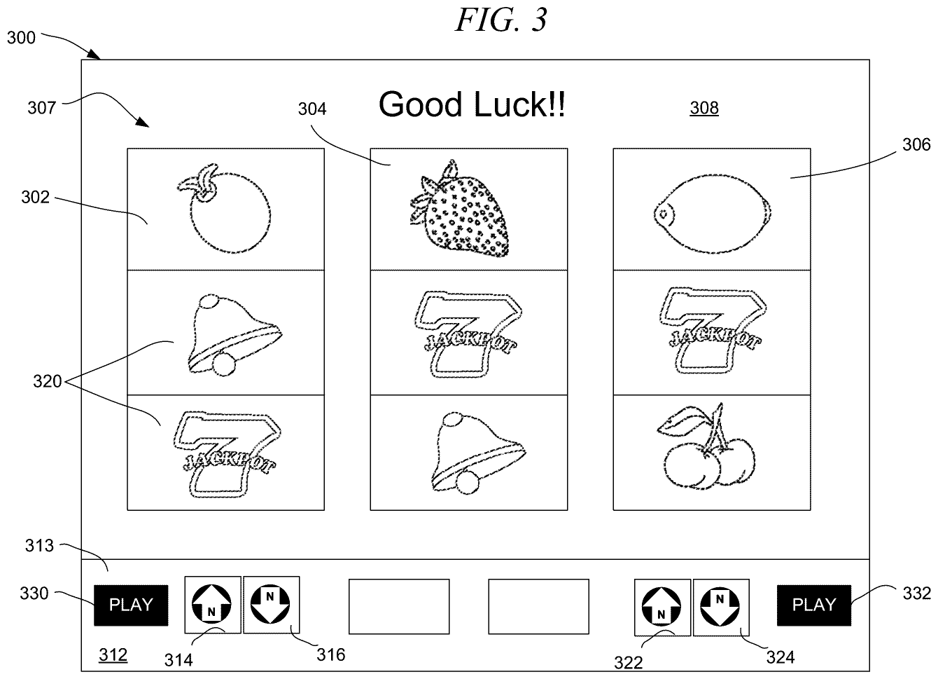

FIG. 3 is a pictorial representation of a portion of a gaming machine 300 in accordance with an illustrative embodiment. As shown the gaming machine 300 may include a first reel 302, a second reel 304, and a third reel 306 (altogether the reels 307). The reels 307 may be video projected onto the primary display 308. Alternatively, the reels 307 may represent physical reels of the gaming machine 300.

The gaming machine 300 may include a user interface 312 that may include buttons 314, 316. In addition, the user interface 312 may include nudge buttons 314, 316. The nudge buttons 314, 316 are dedicated hardware buttons that may be utilized to change initial results of a game played on the gaming machine 300. In one embodiment, the nudge button 314 may be utilized to move one of the reels by one position. As shown, the reels 307 may display any number of symbols 320, writing, numbers, images, or so forth. The nudge buttons 314, 316 may be utilized to move one of the reels 307 and the corresponding symbols 320 to a different position thereby changing the initial results of the game. One or more of the nudge buttons 314, 316 may be illuminated, flash, colored, or otherwise highlighted to indicate to the user that a nudge may change the results of the game. Speakers, tactile feedback, or other indicators may also be provided on the primary display 308 or other displays, indicators, buttons, interfaces, or peripherals of the gaming machine 300 or in communication with the gaming machine 300. The user must select the appropriate nudge buttons 314, 316 to perform the nudge operation. As a result, the games of the gaming machine 300 may be considered skill-based games. In some instances, the user must perform the nudge within a time period associated with the game or else the gaming machine 300 will finalize the initial results without changing the outcome.

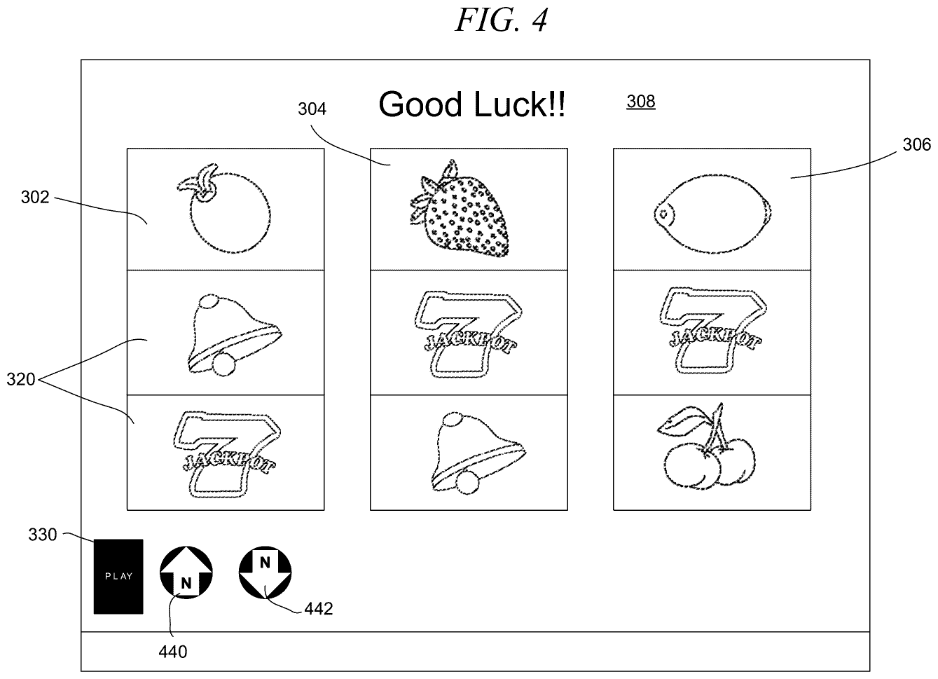

Logic, algorithms, or software of the gaming machine 300 may be utilized to present nudge information to the user. The gaming machine 300 automatically determines the reel that may be nudged in one direction or another to positively affect the game results for the user. The nudge or nudge operation may move one of the reels. For example, if a certain winning symbol combination has missed because a needed symbol is slightly off of the active payline (e.g., by one reel symbol position as shown in FIGS. 3 and 4), a nudge suggestion (e.g., visual, textual, verbal, etc.) or other indicator may indicate the potential nudge to move the needed symbol to the active payline thereby creating a winning combination (or a better combination that the initial results). In some jurisdictions, a skill must be demonstrated in order to win to be considered a skill-based game. As a result, every initial result of a game is a loser with the user presented with options for utilizing nudges for some of the games to affect the results. As a result, every game is a loser unless the player correctly utilizes a nudge or skill to achieve a winning result. The nudge logic may be utilized so that only two dedicated nudge buttons 314, 316 are required to perform nudges for all of the reels 307 of the games of the gaming machine 300. As a result, hardware costs for the gaming machine 300 are significantly reduced while still providing the enhanced game play that the nudge operation allows. For example, the users may have an increased chance of winning and may play the gaming machine longer increasing the user satisfaction, profitability, usage rate, and other metrics associated with the gaming machine 300.

The nudge logic may determine which of all of the possible nudges results is the optimal nudge operation. The optimal nudge operation is the nudge operation that maximizes the winnings of the player (e.g., a winning nudge operation improves initial results of $0 to a winning outcome of $3, winning nudge operation improves initial results of $1 to a winning outcome of $5, etc.). The nudge logic may then present an optimal nudge operation, receive a player selection, and implement the nudge to provide the corresponding outcome.

In one example, the game played on the gaming machine 300 may result in the symbols shown on the reels 307. The nudge logic of the gaming machine 300 may determine that an upward nudge to the reel 302 may positively affect the initial results as shown so that the user may experience a winning combination. The gaming machine 300 may light up one (nudge button 314) or both the nudge buttons 314, 316, play an audio or textual message such as “Use a nudge to win”, vibrate, or give other indicators. As a result, the user may select to rotate the symbols 320 of the reel 302 up by one symbol by selecting the nudge button 314 so that the user may have a winning combination of triple “7” s. Alternatively, the user may press the wrong nudge button (i.e., nudge button 316), fail to make a nudge selection, or accept the initial results as the final results.

FIG. 4 is a pictorial representation of portions of a gaming machine in accordance with an illustrative embodiment. As shown, the primary display 308 may be utilized to display nudge buttons 440, 442. As shown, the nudge buttons 440, 442 may be virtually displayed or projected. The nudge buttons 440, 442 may represent soft buttons that may be positioned on the primary display 308 (or other displays). A reduced number of nudge buttons 440, 442 are displayed from existing machines and systems to reduce complexity, costs, and enhance gameplay. For example, only two nudge buttons 440, 442 may be displayed on the primary display 308 instead of six or more nudge buttons. In another embodiment, the nudge buttons 440, 442 may be displayed in addition to available hardware nudge buttons (see the nudge buttons 314, 316 of FIG. 3 for example).

In one embodiment, the nudge logic of the gaming machine 300 may be utilized to determine when to display nudge buttons 440, 442. As a result, the nudge buttons 440, 442 may be displayed or otherwise communicated only as needed. For example, the nudge buttons 440, 442 may be displayed in response to determining a nudge may positively affect the initial results of the game (i.e., change to a winning combination, enhanced winnings, better combinations, etc.). The nudge buttons 440, 442 may be displayed to one or more different portions of the primary display. For example, the user may indicate whether they are right-handed or left-handed with the nudge buttons 440, 442 being displayed on the corresponding side of the primary display. The user may also select where to display the nudge buttons 440, 442 on the gaming machine.

In addition to being displayed, one or more of the nudge buttons 440, 442 may be further lit up, flash, enlarged, change colors, display messages, display indicators, or otherwise configured when a nudge selection is appropriate. The nudge buttons 440, 442 may include one or more lights, lamps, and/or touch screens that are illuminated. One nudge button may be illuminated or activated, or both of the nudge buttons may be illuminated or activated. In one embodiment, the correct nudge button 440 may be lit up in green while the nudge button 442 may be lit up in red (or not lit up at all). The gaming machine 300 may further highlight the nudge button 440, 442 that best changes the initial results. For example, the nudge button 440 may be highlighted to nudge the reel 302 so that a winning combination of symbols 320 is aligned. Whether the nudge buttons 440, 442 are lit up or otherwise activated may depend on the jurisdiction. For example, some jurisdictions may allow the nudge buttons to light up while others may not to ensure that the proper level of skill is exhibited. Any number of other skill hints may be provided if allowed by the applicable jurisdiction. The gaming machine may be programmed or automatically update the nudges utilized based on the applicable jurisdiction, laws, and/or regulations for the location of the gaming machine. Location information may be determined utilizing GPS, internet connection, programming, registration, or so forth.

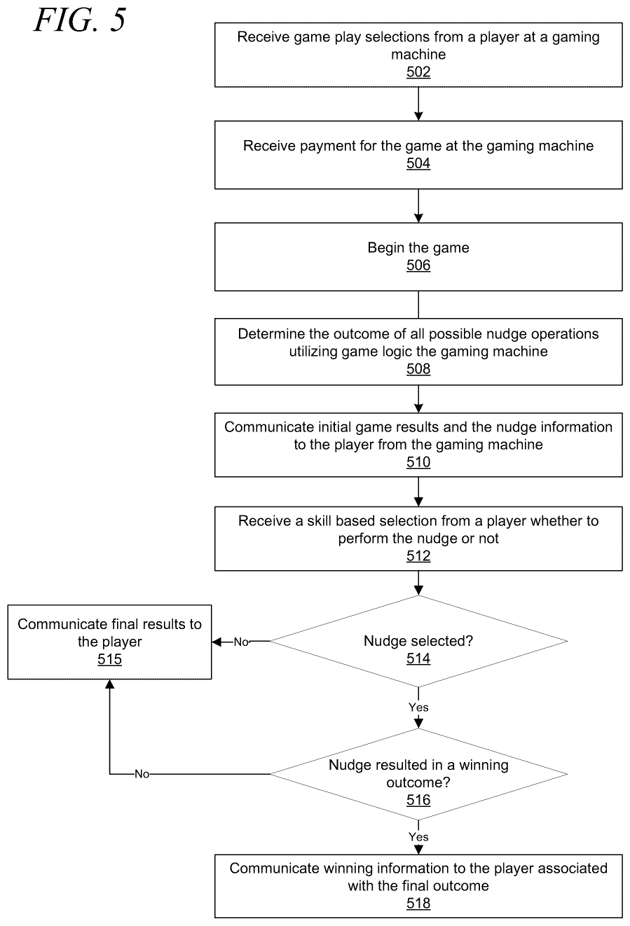

FIG. 5 is a flowchart of a process for implementing a nudge for a gaming machine in accordance with an illustrative embodiment. The process may be implemented by a gaming machine with specific hardware or software utilized to implement the described game and process. For example, the gaming machine may represent a slot machine with a single pair of dedicated nudge buttons or a single pair of virtual nudge buttons that are presented based on results of a game. In one embodiment, the game of FIG. 5 may represent a skill-based game that requires a nudge, selection, or other demonstrated skill for the user to win or otherwise improve the outcome.

The process may begin by receiving game play selections for a user at a gaming machine (step 502). The game selections may include preferences, type of game, wagered amount, payout, nudge information (i.e., number of nudges allowed, nudges purchased, potential to earn nudges, nudge limitations, etc.). The game play selections may control how the game is played within the applicable rules, settings, and limitations set for the gaming machine based on the location and by applicable laws and regulations (if applicable). The type and category of the game may specify how, when, and where the game may be played.

Next, the gaming machine receives payment for the game at the gaming machine (step 504). The payments may be received through hard currency (e.g., coins, bills, etc.), tokens, card (e.g., credit card, room card, RFID card, magnetic card, etc.), bar code, QR code, cryptocurrency, mobile application, or so forth. The payment may be for a single game, series of games, or multiple games (e.g., including number, type, and configuration of the games). The payments may be received after, before, separately, or as part of the game play selections of step 502. Payments for the game may be received at any time before or during the game. For example, step 504 may be before step 502 or may at any time as part of the process of FIG. 5.

Next, gaming machine begins the game (step 506). The game may be initiated in response to a user selection, such as pulling the handle of a slot machine or pressing a button on the gaming machine marked “PLAY”, “BEGIN”, or “START”. The game of FIG. 5 is a game of chance with random results that are unaffected by outside influences, signals, interference, or so forth. As previously noted, the logic of the game may require that the user utilize skill to win the game or an applicable prize. As a result, the initial result may never be a winner until the user provides some input or skill (see for example step 508). In other words, each initial result is a loser until the user exercises some potential skill. Even with the skill option, such as a nudge, the user may still lose a game when a nudge or other skill does not help the user win.

Next, the gaming machine determines the outcome of all possible nudge operations utilizing game logic of the gaming machine (step 508). The game logic may determine which nudge operations, if any, improve on the initial results of the game. For example, a single nudge may be allowed for a three-reel slot-based game and the game logic may determine if a nudge could result in a user win. The logic may utilize simple logic for most games to determine whether a nudge could result in a use win. Alternatively, machine learning or artificial intelligence may be utilized to determine whether the nudge may improve the final results for the user. The game utilized may have a single payline or multiple paylines. As previously noted, the game may utilize reels with symbols, dice, matrices, cards, numbers, symbols, text, or so forth. Any number of games may be implemented for the gaming machine. In one embodiment, the game may require a skill, such as a nudge, to be implemented for a payline to be completed and the user to win the game or a prize.

The logic of the gaming machine determines the outcome of all possible reel nudges (e.g., movement or rotation of one symbol in one direction or another) to determine an optimal nudge operation to present two options one of the options including the optimal nudge operation. The possible nudge operations are reduced for games involving three or more reels to two nudge buttons, such as an optimal nudge and the opposite of the optimal nudge. As a result, multiple nudge buttons (e.g., six or more nudge buttons) are not required and instead two nudge buttons may be utilized.

Next, the gaming machine communicates initial game results and the nudge information to the user from the gaming machine (step 510). The initial game results may be the movement of a number of reels (i.e., virtual/video, mechanical, etc.) and the random combination of symbols displayed by the reels. The simplified nudge information may be communicated to the user in any number of ways. The nudge information may be displayed to the user utilizing one or more displays, buttons, or indicators of the gaming machine that may textually, visually/graphically, or otherwise present the information to the user. The nudge information may also be communicated utilizing one or more speakers of the gaming machine, through a transceiver to a device, via message (e.g., text, email, in-application message, etc.), tactilely, or utilizing other components of the gaming machine or interconnected devices. The nudge information communicated during step 510 may vary by jurisdiction. Whether skill hints are allowed may depend on the applicable jurisdiction (e.g., location), type of game, bet amount, and/or other applicable information and data. For example, some jurisdictions may allow the gaming machine to indicate which of the nudge buttons should be selected while others may not allow any indications at all.

In one embodiment, the nudge information may be communicated by highlighting the reel that may be moved or rotated for the user to win or perform better. The nudge information may also be communicated by lighting up, flashing, or highlighting a dedicated hardware nudge buttons that are integrated with the gaming machine for the user to select to perform the nudge. Using only two nudge buttons decreases the costs of manufacturing and running the gaming machine. Similarly, the game may be simplified with the user experienced enhanced with the potential for more wins based on proper usage of the nudge buttons. In another embodiment, the nudge information may be communicated by displaying virtual nudge buttons that are associated with the reel that must be nudged to win or perform better. For example, only two virtual nudge buttons may be displayed for the reels instead of multiple nudge buttons that traditional systems have used. Pushing the correct nudge button (i.e., up, or down) may be considered a skill required for skill-based gaming and the applicable laws, regulations, and procedures. Pushing the wrong nudge button is entirely possible and will undoubtedly happen to users that are not attentive, careful, or selective enough when playing the game of FIG. 5.

Next, the gaming machine receives a skill-based selection from a user whether to perform one of the available nudge operations or not (step 512). The selection may be an active selection, such as an up or down selection for the nudge. The nudge selection may also be associated with a symbol swap, + or − selection, left or right movement, or other change of the initial game results. In some embodiments, the nudge may be required to be selected within a designated time period (e.g., 15, 30, 60 seconds) before the initial game results are finalized. As previously noted, the nudge selection may be necessary to win the game depending on the initial results of the game. The selection may also be an active selection or a passive selection, such as the user selecting not to perform the nudge (i.e., a passive selection). Choosing not to perform a nudge may preserve nudges for different games, better payouts, or so forth.

Next, the gaming machine determines whether a nudge is selected (step 514). The nudge selection or non-selection may be received from the user during step 512. If the nudge is not selected, the initial results are the final results, and the gaming machine communicates the final game results to the user (step 515). For example, the user may have lost the game or may have won a lesser amount by not selecting to use a nudge.

If the nudge is selected during step 514, the gaming machine determines whether the nudge resulted in a winning outcome (step 516). If a winning nudge was not selected, the gaming machine communicates the final results to the user (step 515). For example, the losing results or lesser winnings may be communicated to the user.

If the gaming machine determines a winning nudge was selected during step 516, the gaming machine communicates winning information to the player associated with the final outcome (step 518). The winning information as well as any winnings may be provided to the user.

The process of FIG. 5 may be performed repeatedly while the user is willing and able to play the game. The user may select to begin or end gameplay at any time.

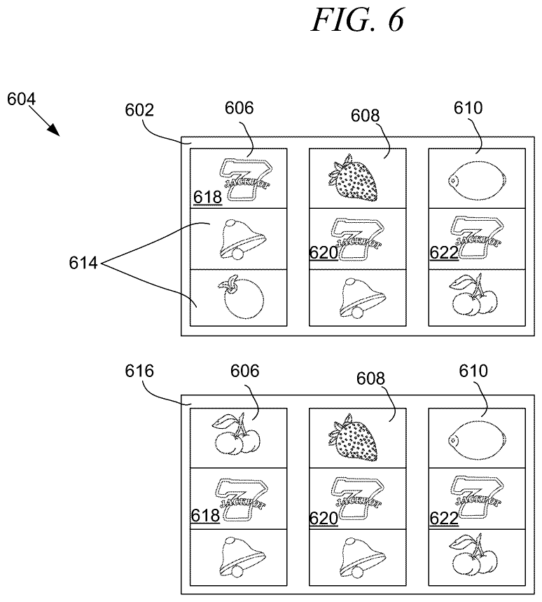

FIG. 6 is a pictorial representation of a nudge operation in accordance with an illustrative embodiment. FIG. 6 shows initial results 602 for a three-reel skill based game 604 for reels 606, 608, 610. The game 604 may be affected by the result of a nudge operation. The game 604 is shown after the initial result 602. Based on the initial result 602, the player may be automatically presented with the opportunity to nudge reel 606. In the initial result 602s, symbols 618, 620, 622 are not aligned to reach a winning combination or payline. The player may utilize nudge buttons as are shown in FIGS. 3 and 4. For example, the player may utilize a down nudge button to nudge reel 606 moving symbol 618 down.

The player may nudge the reel 606 down so that a winning combination of symbols 614 is reached for the final outcome 616. As shown, the reel 606 is nudged utilizing a down nudge button so that symbol 618 aligns with symbols 620 and 622 in the final outcome 616.

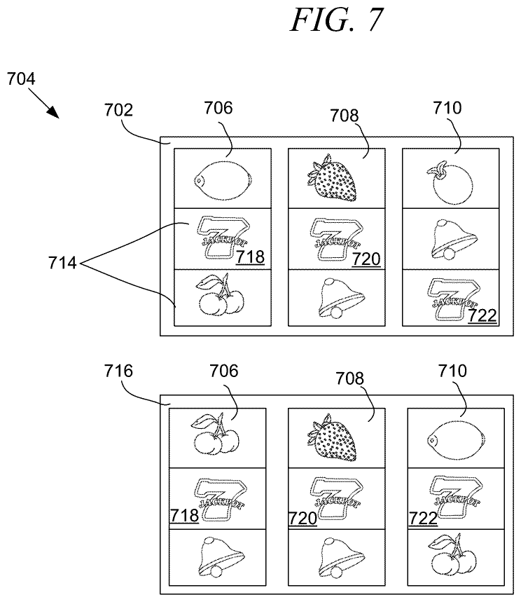

FIG. 7 is another pictorial representation of a nudge operation in accordance with an illustrative embodiment. FIG. 7 shows initial results 702 for a three-reel skill based game 704 for reels 706, 708, 710. The game 704 may be affected by the result of a nudge operation. The game 704 is shown after the initial result 702. Based on the initial result 702, the player may be automatically presented with the opportunity to nudge reel 710. In the initial result 702, symbols 718, 720, 722 are not aligned to reach a winning combination or payline. The player may utilize nudge buttons as are shown in FIGS. 3 and 4. The player may nudge reel 710 with an up nudge button so that symbol 722 reaches a winning outcome aligned with symbols 718, 722 as shown in the final outcome 716.

The illustrative embodiments are utilized to simplify gameplay. The nudge logic for determining whether a nudge is relevant or helpful is utilized to ensure that a limited number of nudge buttons are utilized. The gaming machines may be built with less hardware than required for devices with a pair of nudge buttons per reel (typically 6 or more nudge buttons). As a result, the rate of play is increased and player satisfaction with the game is enhanced.

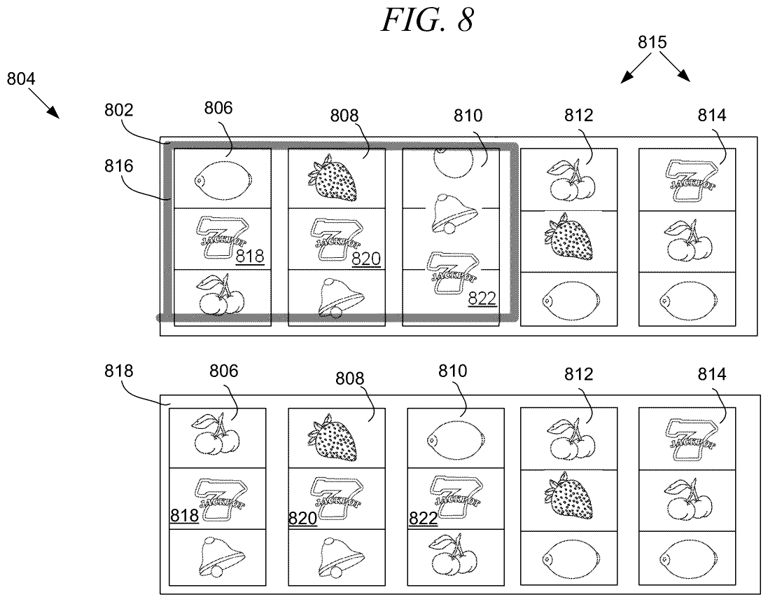

FIG. 8 is another pictorial representation of a nudge operation in accordance with an illustrative embodiment. FIG. 8 shows initial results 802 for a five-reel skill-based game 804. As is known, three row games may have 10, 20, or even 243 paylines (3×3×3×3×3).

As shown, the game 804 may have reels 806, 808, 810, 812, 814 (altogether reels 815). In one embodiment, a portion of the reels 815 may be marked by a highlight 16. The highlight 816 may indicate to the user the portion of the reels 815 that may be positively affected by a nudge (or alternatively a swap). For example, the initial results 802 may be affected by the result of a nudge operation. Based on the initial result 802, the game 804 may automatically present the player with the opportunity to nudge reel 810 up or down. In the initial result 802, symbols 818, 820, and 822 are not aligned to reach a winning combination or payline. In one embodiment, the reel 810 may be partially aligned so that the player may quickly determine that a nudge may be utilized to achieved a desired result as shown in the final outcome 818. The reel 810 may be offset or partially aligned to illustrate to the user that a nudge may affect the final outcome 818 based on a nudge operation.

In another embodiment, the symbols associated with the reel 810 may be rotated. The highlight 816 may also be utilized to emphasize the reels that may be affected by a nudge operation. In other embodiments, multiple highlights may be utilized for all or different portions of the reels 815. For example, one or multiple reels 815 may be highlighted. The highlight 816 may represent a lighted, colored, our outlined portion of the reels 815, symbols, outlines, or so forth. The highlight 816 may also represent a distinct demarcation. The symbols within the highlight 816 may represent the original symbols 818, 820, and 822. In another embodiment, the symbols within the highlight 816 may be shown as different symbols making the need for the nudge more clear or more exciting to the player. Swapping out the symbols may provide additional clarity for the player and remind the player of nudge operations they have performed for other games.

In another embodiment, the nudges herein disclosed may also represent swapping of symbols between locations in the initial results. A swap may be performed to reach a better final result.

The illustrative embodiments provide an enhanced gaming machine and method for playing a multi-reel skill game that utilizes nudges. The number of buttons required in the button deck are decreased significantly. Instead of numerous nudge buttons (e.g., six nudge buttons), only two buttons are required. In some embodiments, a pair of nudge buttons may be placed on either side of the gaming machine near a play button for left-handed and right-handed players. The use of limited nudge buttons (i.e., one pair or two) reduces costs of the gaming machine and makes game play faster and simpler, particularly for those with limited motion. The logic of the gaming machine determines when a nudge may affect the final outcome based on initial results of the skill-based game. For example, the logic may determine that nudging one of the multiple reels up or down may result in a winning outcome for the user. That determination may be communicated with the user or made available to be implemented. One or both of the nudge buttons may flash, change colors, play an alert, illuminated, or otherwise highlighted for the user when a nudge may affect the initial results. Upon selection of the correct, nudge button a nudge operation is performed on the reels to produce a winning outcome. An improper selection of a nudge button results in a losing outcome.

As a result, the illustrative embodiments provide a gaming machine, system, and method that allow individuals with disabilities or mobility issues to more effectively play the skill-based game. Further the game may be played more quickly and easily speeding game play and enhancing the experience.

The illustrative embodiments are utilized to simplify gameplay. The nudge logic for determining whether a nudge is relevant or helpful is utilized to ensure that a limited number of nudge buttons are utilized. The gaming machines may be built with less hardware than required for devices with numerous nudge buttons (e.g., 6 or more nudge buttons). As a result, the rate of play is increased and player satisfaction with the game is enhanced.

The illustrative embodiments are not to be limited to the particular embodiments and examples described herein. In particular, the illustrative embodiments contemplate numerous variations in the type of ways in which embodiments of the invention may be applied to implementing a nudge for various gaming machines, gaming firmware, gaming software, or so forth. The foregoing description has been presented for purposes of illustration and description. It is not intended to be an exhaustive list or limit any of the disclosure to the precise forms disclosed. It is contemplated that other alternatives or exemplary aspects are considered included in the disclosure. The description is merely examples of embodiments, processes, or methods of the invention. It is understood that any other modifications, substitutions, and/or additions may be made, which are within the intended spirit and scope of the disclosure. For the foregoing, it can be seen that the disclosure accomplishes at least all of the intended objectives.

The previous detailed description is of a small number of embodiments for implementing the invention and is not intended to be limiting in scope. The following claims set forth a number of the embodiments disclosed with greater particularity.

What is claimed is:

1. A gaming machine implementing an optimized nudge operation, comprising:
a processor for executing a set of instructions to implement a game;
a memory in communication with the processor for storing the set of instructions;
a value interface in communication with the processor for receiving payment from a user to play the game;
nudge logic for determining an effect of all possible nudge operations on initial results of the game when played by the user; and
two hardware nudge buttons for selecting among the nudge operations for the game to change the initial results to final outcome for the game.

2. The gaming machine of claim 1, further comprising:
a payoff mechanism for paying the user for the final outcome of the game.

3. The gaming machine of claim 1, wherein the nudge logic illuminates one or more of the two hardware nudge buttons to indicate a nudge operation would improve the initial results.

4. The gaming machine of claim 1, wherein the game is a skill-based game utilizing the nudge operation, wherein the nudge operation is a skill required by a jurisdiction associated with a location of the gaming machine, and wherein the user is capable of making a wrong choice between the two hardware nudge buttons or not selecting one of the two hardware nudge buttons.

5. The gaming machine of claim 1, wherein the game is a reel-based game that the user wins by aligning random combinations of symbols on reels of the game.

6. The gaming machine of claim 5, wherein the game displays at least three reels during the game.

7. The gaming machine of claim 5, wherein the two hardware nudge buttons are an up nudge button and a down nudge button that are applicable to one reel at a time as determined by the nudge logic.

8. The gaming machine of claim 1, wherein the gaming machine is networked with a plurality of gaming machines.

9. The gaming machine of claim 1, wherein the gaming machine is a slot machine.

10. The gaming machine of claim 1, wherein the gaming machine suggests a nudge to the user utilizing a user interface as a skill hint.

11. The gaming machine of claim 1, wherein the gaming machine is limited to two dedicated nudge buttons for games of the gaming machine.

12. The gaming machine of claim 1, wherein the nudge is a change, movement, or swap of at least two components of the initial results.

13. The gaming machine of claim 1, wherein the nudge operation is a skill required for the user to win on one or more paylines of the game, and wherein the user cannot win without selecting a correct button from the two or more hardware nudge buttons.

14. A method for implementing enhanced nudging for a gaming machine, comprising:
receiving game play selections from a user utilizing a gaming machine;
receiving payment for a game implemented on the gaming machine;
initiating the game in response to a user selection;
determining an effect of all possible nudge operations on the initial results of the game;
communicating the initial results of the game to the user;
offering two nudge operations utilizing a display of the gaming machine including at least a nudge operation with a best possible outcome;
receiving a selection from the user which of the two nudge operations to perform or a non-selection; and
communicating winning information to the user in response to the user performing the nudge operation.

15. The method of claim 14, wherein the two nudge buttons are utilized to move one of a plurality of reels in one direction or another, and wherein the two nudge buttons include an up nudge button and a down nudge button, and wherein only the two nudge buttons are displayed even though the game includes a plurality of reels.

16. The method of claim 14, further comprising:
indicating whether a nudge would improve the initial results of the game for the benefit of the user utilizing two nudge buttons communicated to the user on a display of the gaming machine.

17. The method of claim 14, wherein the gaming machine is a slot machine with logic for implementing nudge operations.

18. A gaming machine, comprising:
a user interface for displaying information to a user and receiving selections from the user;
a payment system for receiving one or more payments from a user; and
logic for implementing a nudge operation for a game, wherein the logic initiates the game in response to a user selection, determines an effect of all possible nudge operations on the initial results of the game, communicates the initial results of the game to the user through the user interface, offers two nudge operations utilizing a display of the gaming machine including at least a nudge operation with a best possible outcome, receives a selection from the user through the user interface indicating which of the two nudge operations to perform or a non-selection; and communicates winning information to the user in response to the user performing the nudge operation.

19. The gaming machine of claim 18, wherein the user interface lights up the nudge operation with the best possible outcome.

20. The gaming machine of claim 18, wherein the game includes three or more reels, and wherein the nudge requires skill by the user to select correctly between the two nudge buttons to change the initial results to winning results associated with the winning information.
